(19) United States
(12) Patent Application Publication
(10) Pub. No.: US 2026/0218836 A1
(43) Pub. Date: Jul. 30, 2026

(54) SELF-PROPELLED ROBOT

(71) Applicant: University of Notre Dame du Lac, South Bend, IN (US)

(72) Inventors: Margaret Mary Coad, South Bend, IN (US); Nelson G. Badillo Perez, South Bend, IN (US)

(21) Appl. No.: 19/145,939

(22) PCT Filed: Mar. 10, 2024
(86) PCT No.: PCT/US2024/019300

§ 371 Date: Jul. 6, 2025

Related U.S. Application Data
(60) Provisional application No. 63/451,438, filed on Mar. 10, 2023.

(51) Int. Cl. F16L 55/32; F16L 55/40

(52) U.S. Cl. CPC F16L 55/32; F16L 55/40

(57) ABSTRACT

A self-propelled robot that includes a membrane and a core. The membrane defines a membrane axis therethrough and includes a first end and a second end opposite the first end. The membrane also defines a central volume therein, and includes a central channel extending axially therethrough that is open to both the first end and the second end. The core is positioned within the central volume and includes a drive mechanism configured to engage and circulate the membrane about an infinite loop.

### CROSS-REFERENCE TO RELATED APPLICATION

The present application is a formalization of U.S. Provisional Patent Application No. 63/451,438, filed Mar. 10, 2023. The entire contents of which are hereby incorporated by reference.

### FIELD

The present disclosure relates to a self-propelled robots and, in particular, self-propelled robots for navigation in confined spaces.

### BACKGROUND

There are many spaces inaccessible to humans where robots could help deliver sensors and equipment. Many of these spaces contain three-dimensional passageways and uneven terrain that pose challenges for robot design and control.

### SUMMARY

In one aspect, a self-propelled robot including a membrane defining a membrane axis therethrough, where the membrane includes a first end and a second end opposite the first end, where the membrane defines a central volume therein, and where the membrane includes a central channel extending axially therethrough that is open to both the first end and the second end, and a core positioned within the central volume, where the core includes a drive mechanism configured to engage and circulate the membrane about an infinite loop.

Alternatively or additionally, in any combination, where the membrane is toroidal in shape.

Alternatively or additionally, in any combination, where the membrane includes a single continuous outer surface and a single continuous inner surface.

Alternatively or additionally, in any combination, where the central volume is fluid-tight.

Alternatively or additionally, in any combination, where the membrane is formed from material that is between 0.1 mm and 0.5 mm thick.

Alternatively or additionally, in any combination, where the three-dimensional shape of the membrane is defined by a wall profile rotated 360 degrees about the membrane axes, and where the wall profile includes a wall forming a closed shape.

Alternatively or additionally, in any combination, where the toroidal membrane includes a tail including the portion of the membrane forming the central volume, and where the drive mechanism engages and biases the tail axially toward the first end.

Alternatively or additionally, in any combination, where the drive mechanism includes a pair of rollers each rotatable about a corresponding roller axes, and where the rollers are positioned such that both roller axes are oriented perpendicular to the membrane axes.

Alternatively or additionally, in any combination, where the rollers are positioned adjacent one another to form a pinch-point therebetween, and where at least a portion of the toroidal membrane passes through the pinch-point.

Alternatively or additionally, in any combination, where circulating the membrane about an infinite loop includes everting the membrane as it extends from the central channel proximate the first end, and inverting the membrane as it retracts into the central channel proximate the second end.

Alternatively or additionally, in any combination, where the central volume remains substantially constant as the membrane circulates about the infinite loop.

In another aspect, a self-propelled robot including a membrane defining a membrane axis therethrough, where the membrane includes a first end and a second end opposite the first end, where the membrane defines a fluid-tight central volume therein, and where the membrane includes a central channel extending co-axially with the membrane axis therethrough that is open to both the first end and the second end, and a core positioned within the central volume, where the core includes a drive mechanism configured to engage and apply a force to the membrane during use.

Alternatively or additionally, in any combination, where applying a force to the membrane causes the self-propelled robot to travel in a first direction parallel to the membrane axis.

Alternatively or additionally, in any combination, where the membrane is toroidal in shape.

Alternatively or additionally, in any combination, further including a controller positioned in the central channel and in operable communication with the drive mechanism, where the controller receives signals wirelessly via a wireless receiver.

Alternatively or additionally, in any combination, where the controller receives signals wirelessly from a remote user interface.

Alternatively or additionally, in any combination, where the core includes a first portion and a second portion pivotable relative to the first portion about an axis that is oriented perpendicular to the membrane axis.

Alternatively or additionally, in any combination, where the central channel passes through both the first portion and the second portion of the core.

Alternatively or additionally, in any combination, where the dive mechanism is attached to the second portion of the core.

In another aspect, a self-propelled robot including a membrane having a toroidal shape and defining a fluid-tight volume containing pressurized air therein, and a core positioned within the volume, where the core includes a drive mechanism configured to engage and apply a force to the membrane during use causing the robot to travel.

### BRIEF DESCRIPTION OF THE DRAWINGS

FIG. 1 illustrates a self-propelled toroidal robot in various stages of locomotion across a horizontal support surface.

FIG. 2A is an exploded view of a core of the self-propelled toroidal robot of FIG. 1.

FIG. 2B is a perspective view of the core of FIG. 2A.

FIG. 2C is a section view of the self-propelled toroidal robot of FIG. 1 taken along the membrane axis.

FIG. 2D is a perspective view of the core of FIG. 2B with a battery pack attached thereto.

FIGS. 3A-3F illustrate the various stages of installing a membrane onto the core of FIG. 2A.

FIG. 4A illustrates a force diagram of the self-propelled toroidal robot of FIG. 1 within a pipe set at angle θ from horizontal.

FIG. 4B is a detailed force diagram of the core of FIG. 4A.

FIG. 4C is a detailed force diagram of the driven rollers of the core of FIG. 4B.

FIG. 5A illustrates an experimental setup used to measure the minimum propulsion device motor voltage required to begin climbing a pipe at different angles relative to horizontal.

FIG. 5B illustrates the results of the minimum propulsion device motor voltage experiment.

FIG. 6 illustrates the results of the slipping force validation experiment.

FIGS. 7A-7F illustrate the self-propelled toroidal robot of FIG. 1 propelling itself along a horizontal maze.

FIG. 8 illustrates an experimental setup demonstrating the self-propelled toroidal robot of FIG. 1 climbing up a vertical pipe.

FIG. 9 illustrates another embodiment of a core of a self-propelled toroidal robot having active steering capabilities.

FIGS. 10-14 illustrate the various stages of applying a membrane to the core of FIG. 9.

FIGS. 15 and 16 are top schematic views of the self-propelled toroidal robot of FIG. 8 in various steering positions.

FIG. 17 illustrates another embodiment of the self-propelled toroidal robot with an external camera installed thereon.

FIGS. 18-20 illustrate various embodiments of drive mechanisms for use in the core of the self-propelled toroidal robot of FIG. 1.

### DETAILED DESCRIPTION

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

Navigating confined spaces that are inaccessible to humans has long been a challenge for robot design and control. Inspection inside pipes, exploration in rubble, movement inside the human body, and monitoring in outdoor animal burrows are all examples of real-world scenarios where robots capable of confined-space navigation could prove helpful. Often, these spaces contain three-dimensional passageways that are difficult to navigate for robots that are unable to brace themselves against the environment-which in certain circumstances can include uneven, sharp, or otherwise abrasive features. Furthermore, such spaces may include blockages that must be avoided.

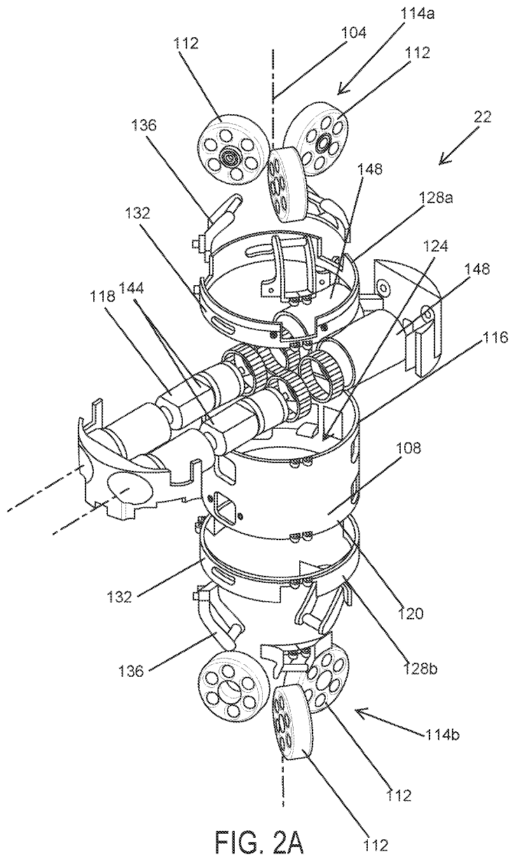

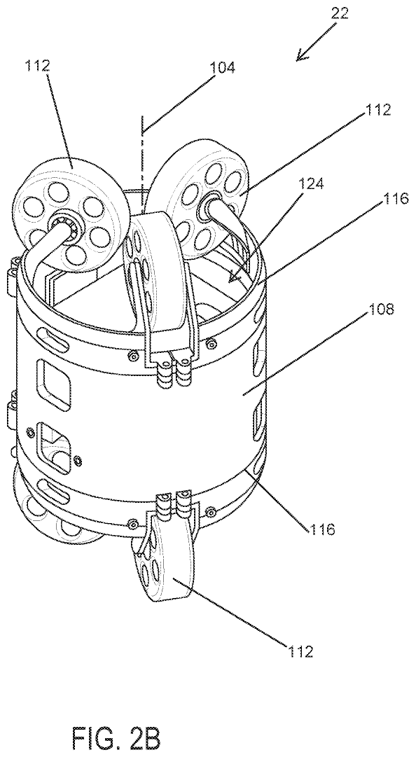

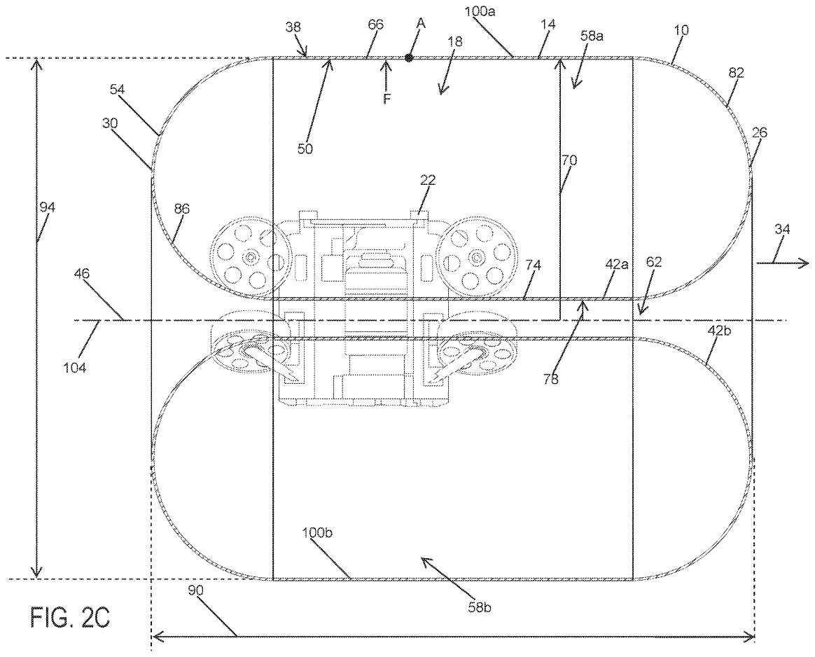

FIGS. 2A-2D illustrate a self-propelled robot 10 with soft exterior membrane 14 for travel along confined areas such as pipes, through rubble, inside the human body, within animal burrows, and the like. More specifically, the robot 10 includes a toroidal membrane 14 defining a fluid-tight central volume 18, and a core or drive member 22 positioned within the volume 18. During use, the core 22 exerts forces against the toroidal membrane 14, causing the membrane 14 to evert (e.g., turn inside-out) at the leading end 26 while simultaneously inverting (e.g., turning outside-in) at the trailing end 30 so that the entire membrane 14 circulates about an infinite loop to propel the robot 10 in a first direction 34. Stated differently, the robot 10 is a toroidal robot 10 that continuously recycles an air-filled membrane 14 using a motorized device 22 that is inside the pressurized volume 18 thereof. Furthermore, the central volume 18 may remain fluid-tight during operation and locomotion, only the exterior surface 38 of the membrane 14 is exposed to the environment during operation and locomotion, the robot 10 is not limited in range by the physical layout of the membrane 14, and the robot 10 does not require any form of physical connection to a control source or channel opening during operation.

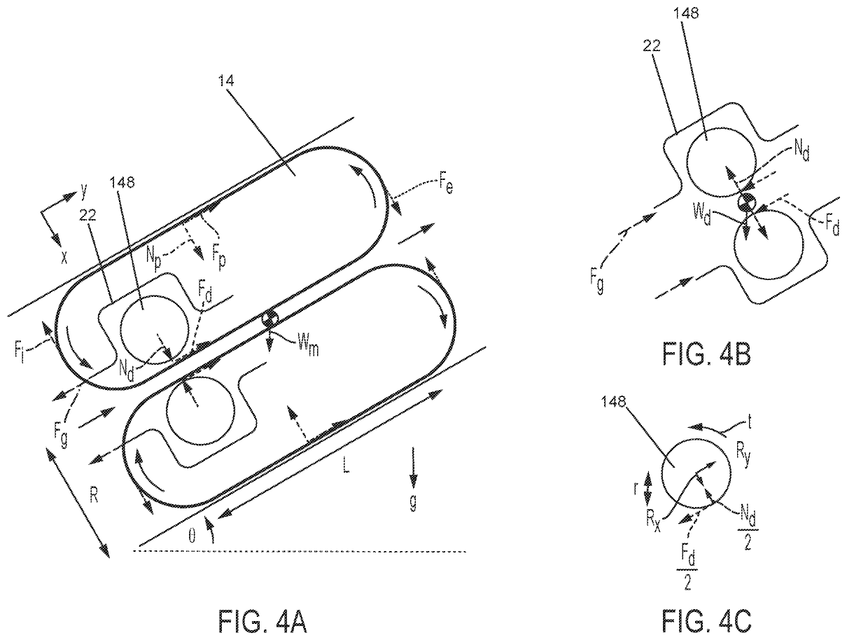

As shown in FIGS. 2C and 4A, the membrane 14 of the self-propelled robot 10 includes a flexible wall 42 that is generally toroidal in shape and defines a membrane axis 46 therethrough. The wall 42, in turn, forms a single, continuous outer surface 38 and a single, continuous inner surface 50 opposite the outer surface 38 that defines the central cavity 18. The membrane 14 is formed from a high-compliance, airtight material having a relatively thin thickness or “sheet” construction. In the illustrated embodiment, the membrane 14 is formed from low-density polyethylene (LDPE) plastic. The LDPE was in part selected due to its high-compliance, airtight capability, low cost, and ability to be sealed using a heat sealer (discussed below). However, in other embodiments different materials may be used.

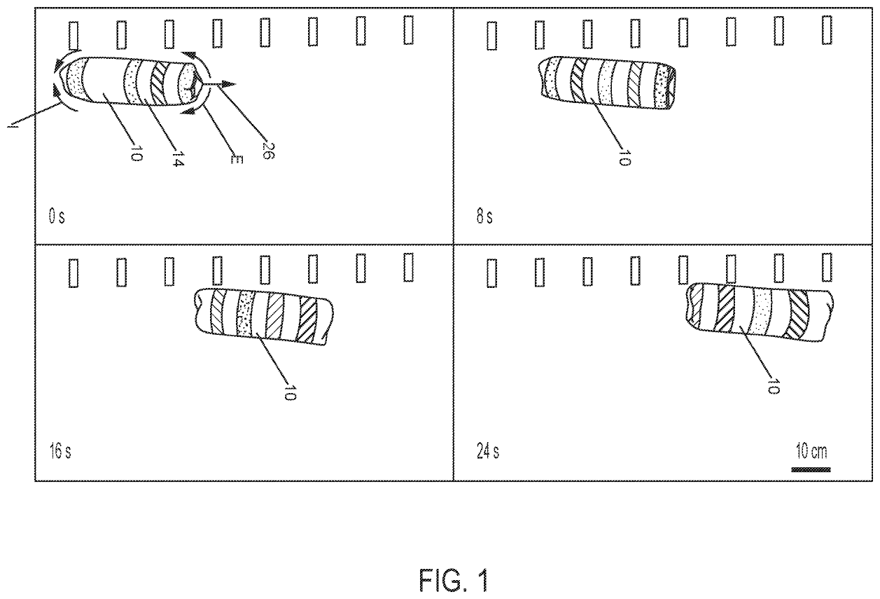

While the illustrated membrane 14 is generally translucent in color and has an unadorned outer surface 38, it is understood that in other embodiments textures, grips, windows, access panels, identification markings, and the like may also be incorporated into or applied to the membrane 14 to improve grip, resist puncture, allow the user to selectively access the central volume 18, allow external devices to better record the robot's 10 movement (see FIG. 1), and the like. While the illustrated membrane 14 is formed from a single sheet of LDPE that has been sealed at one end (discussed below), it is understood that in other embodiments the membrane 14 may be formed from multiple pieces of material that are otherwise attached to one-another to form the final toroidal shape.

In the illustrated embodiment, the wall 42 of the membrane 14 has a thickness between 0.1 mm and 0.5 mm. In other embodiments, the membrane thickness may be approximately 0.1 mm, 0.2 mm, 0.3 mm, 0.4 mm, 0.5 mm, 0.6 mm, 0.7 mm, 0.74 mm, 0.75 mm, and 0.8 mm (±10%). In still other embodiments, the thickness of the wall 42 may be between 0.1 mm and 0.8 mm. In still other embodiments, the thickness of the wall 42 may be between 0.7 mm and 0.8 mm. In still other embodiments the membrane 14 may be 4 mm thick. In still other embodiments, the membrane 14 may be between 0.1 mm and 4 mm thick. How thin the membrane 14 can be in a given situation is generally limited by the material's ability to resist puncture and tearing when interacting with the surfaces of the environment in which it is intended to operate. Anticipated operating pressure within the volume 18 may also influence the minimum thickness of the membrane 14 if higher pressures are anticipated.

During use, the force required to circulate the membrane 14 (e.g., evert and invert the membrane 14 simultaneously) has a direct liner relationship with the membrane thickness (discussed below). Specifically, the greater the thickness the greater the force needed to circulate the material. This relationship has a greater dependence the smaller the outer diameter of the membrane 14. As such, the user is tasked with using a material that is sufficiently thick so that no rips or tears appear, but yet sufficiently thin so that the forces required to circulate the material are not too thick so as to outstrip the torque capabilities of the motor(s) to circulate the membrane 14 during operation (e.g., evert and invert the membrane 14 simultaneously).

In some embodiments, the material and thickness of the membrane 14 may be customized for specific jobs or tasks that the robot 10 is intended to accomplish. For example, in instances where sharp or jagged edges are expected, a thicker and more durable material may be selected. Still further, in instances where specific chemicals may be encountered, a membrane 14 formed from materials compatible with those chemicals may be used. In still other embodiments, in instances where the robot 10 will be in contact with the human body, a sterilizable material may be used.

In still other embodiments, the material forming the membrane 14 may have conductive properties to allow for electrical connections to be conveyed through the membrane 14 during operation. More specifically, wired connections may be established through the portions of the membrane 14 that have conductive properties without having to physically pierce or pass through the membrane 14 itself. In such embodiments, select and electrically isolated regions in the membrane 14 may be conductive to permit the same number of circuits pass through the membrane 14. For example, two conductive tracks (not shown) of conductive material may be incorporated into the membrane 14 to allow for a positive and ground circuit.

The toroidal shape of the membrane 14 is defined by rotating a cross-sectional shape (e.g., a rotated profile 54) about the membrane axis 46 a full 360 degrees. As shown in FIG. 2C, the rotated profile 54 of the membrane 14 includes the wall 42 forming a closed shape that, in turn, is spaced a distance from the membrane axis 46. Alternatively, a cross-sectional shape of the membrane 14 taken along the membrane axis 46 includes two lobes 100a, 100b placed on either side of the membrane axis 46 and spaced a distance therefrom (see FIG. 2C). Each lobe 100a, 100b, in turn, includes a wall 42a, 42b enclosing an interior area 58a, 58b therein.

The membrane 14 also defines a central channel 62 extending the axial length of the membrane 14 and open to both the leading end 26 and the trailing end 30. In the illustrated embodiment, the channel 62 is positioned co-axial to the membrane axis 46.

As shown in FIG. 2C, the rotated profile 54 defining the shape of the membrane 14 includes an exterior wall portion 66 spaced a first radial distance 70 from the membrane axis 46, an interior wall portion or tail 74 spaced a second radial distance 78 from the membrane axis 46 that is less than the first radial distance 40, a leading wall portion 82, and a trailing wall portion 86. When assembled, the exterior wall portion 66 generally includes the portion of the wall 42 that is in contact with the surroundings of the robot 10 at a given time while the interior wall portion 74 generally includes the portion of the wall 42 that defines the central channel 62 at a given time.

In the illustrated embodiment, the rotated profile 54 is generally “pill-shaped” with the interior and exterior wall portions 66, 74 being generally linear and extending parallel to the axis 46. As shown in FIG. 2C, the interior and exterior wall portions 66, 74 are generally elongated so that the overall axial length 90 of the membrane 14 is greater than the width 94 taken normal to the axis 46. In some embodiments, the axial length 90 of the membrane 14 may be increased to improve overall traction (e.g., increase the amount of exterior surface area in contact with the surroundings) without having to increase the axial length of the core 22 or incorporate additional supporting members therein. However, in other embodiments different shapes, and sizes of membrane 14 may be used. In the illustrated embodiment, the diameter or width 94 of the membrane 14 taken normal the axis 46 is between 8 cm and 9 cm. In other embodiments, the diameter or width 94 is approximately 8 cm, 8.5 cm, and 9 cm (±10%). In still other embodiments the diameter 94 of the membrane 14 is 13.7 mm. In still other embodiments, the diameter 94 of the membrane is between 13 mm and 14 mm.

While the illustrated membrane 14 is shown having a rotated profile 54 that is constant as it extends circumferentially about the axis 46 (e.g., the membrane 14 is symmetrical about the axis 46). It is understood that in other embodiments, the rotated profile 54 may vary as it extends circumferentially about the axis 46 to produce a three-dimensional shape that is not symmetric about the axis 46. For example, in some embodiments the membrane 14 may be shaped so that it is wider horizontally than vertically tall. In such embodiments, the wall 42 of the rotated profile 54 may still form a closed shape at all points despite undergoing changes in shape and size.

During use, the closed-loop cross-sectional shape of the wall 42 permits the material of the membrane 14 to circulate in an infinite loop like a continuous, three-dimensional track. More specifically, for a given point A on the wall 42, the point A may circulate about the perimeter of the membrane 14 traveling along a loop in response to the driving force provided by the core 22 (discussed below). For example, application of a forward driving force by the core 22 upon the membrane 14 (e.g., to travel in the first direction 34) will cause the membrane material to circulate such that the given point A, originating on the exterior wall portion 66, will travel rearward toward the trailing end 30, invert as it travels along the trailing wall portion 86, is conveyed forward to the leading end 26 as it travels along the interior wall portion 74, and is then everted as it travels along the leading wall portion 82 to return to the exterior wall portion 66.

The three-dimensional central volume 18 defined by the membrane 14 is also substantially toroidal in shape, is fluid tight, and extends around the membrane axis 18. During use, the central volume 18 is capable of remaining fluidly sealed during operation and locomotion of the robot 10. As such, items positioned within the volume 18 (e.g., the core 22) may be isolated and protected from the local environment without hampering the operation of the robot 10 itself. In the illustrated embodiment, the central volume 18 is configured so that it maintains a substantially constant volume during operation of the robot 10 (e.g., in some embodiments the volume of the central volume 18 does not fluctuate more than ±1%, ±2%, ±3%, ±5%, and ±10% during one full circulation of the membrane 14) such that no coordinated inflation or deflation of the volume 18 is required to maintain the volume 18 at a pre-determined pressure during locomotion. In other embodiments, the pressure within the central volume 18 does not fluctuate more than ±1%, ±2%, ±3%, ±5%, and ±10% during one full circulation of the membrane 14.

When assembled, the central volume 18 is filled with a fluid such as compressed air to inflate and provide increased rigidity to the membrane 14. More specifically, the volume of air within the central volume 18 provides an outward pressure against the walls 42 of the membrane 14 which serves to both inflate the membrane 14 and give it shape. When in situ, the air pressure also provides an outward traction force F normal to the outer surface 38 and into engagement with the robot's surroundings (when present). When the robot 10 is located in a confined space (e.g., like a pipe, human cavity, and the like) the traction force F serves to increase frictional engagement between the outer surface 38 of the membrane 14 and the walls of the confined space. As such, adjusting the fluid pressure within the volume 18 serves to change the magnitude of the traction force F generated between the membrane 14 and the surrounding walls of the confined space. More specifically, increasing the fluid pressure within the volume 18 serves to increase the traction force in a generally linear relationship.

In the illustrated embodiment, the fluid pressure, and as a corollary the traction force F, may be adjusted independently of any operation or output of the drive mechanism 118. More specifically, the inflatable nature of the membrane 14 allows the membrane 14 to be easily adapted to different situations independent of the physical makeup and size of the core 22 or the driving torque output by the motors 144 (discussed below). Membranes 14 having different widths 94 and axial lengths 90 may be interchangeably paired with a single core 22 design yet have independent control over the traction force F exerted against the surrounding walls by adjusting the internal fluid pressure. Stated differently, since the membrane 14 relies on air pressure within the volume 18 to generate the traction force F equally at all points along the exterior wall portion 66, no internal linkage or support frame is needed for that purpose. As such, the core 22 need not interact with the membrane 14 (e.g., specifically the exterior wall portion 66) for that purpose.

When unconstrained (e.g., when not in a confined space), adjusting the fluid pressure within the central volume 18 may serve to influence the overall dimensions of the membrane 14. More specifically, increasing the fluid pressure may cause at least one of the width 94 and the axial length 90 of the membrane 14 to increase while decreasing the fluid pressure may cause at least one of the width 94 and the axial length 90 of the membrane 14 to decrease.

While the illustrated membrane 14 is filled with air, it is understood that in other embodiments other fluids may be used such as water, oils, nitrogen, other gasses, and the like to accommodate the specific operating conditions expected to be encountered. For example, in some embodiments the volume 18 may be filled with mineral oil. In such embodiments where a liquid is used, the core 22 may be sealed or otherwise waterproofed to accommodate the presence of the liquid.

As shown in FIGS. 2A, 2B, and 2D, the core or propulsion device 22 of the robot 10 is positioned within the central volume 18 and is configured to exert a driving force against the membrane 14 while simultaneously helping to direct the movement of the membrane material as it circulates. As shown in FIG. 2A, the core 22 generally encompasses the central channel 62 (e.g., the interior wall portion 74) which allows the core 22 to remain supported proximate the center of the inflated membrane 14 (e.g., so the core axis 104 remains generally co-axial with the membrane axis 18). The illustrated core 22 includes a main body 108 defining the core axis 104, a set of guide rollers 112 rotatably coupled to the main body 108, and a drive mechanism 118 mounted to the main body 108 and configured to operatively engage the membrane 14.

The body 108 of the core 22 is substantially toroidal in shape including a first or leading end 116, and a second or trailing end 120 opposite the first end 116. As shown in FIG. 2C, the core 22 is sized and shaped to be positioned and supported within the central volume 18 of the membrane 14. Specifically, the body 108 defines a central passage 124 therethrough that is configured to allow the interior wall portion or tail 74 of the membrane 14 to pass therethrough. While the illustrated body 108 is substantially circular in cross-sectional shape, it is understood that in other embodiments, different body shapes maybe used (e.g., rectangular, polygonal, and the like) that encompass the tail 74 while still fitting within the central volume 18.

The core 22 also includes a plurality of guide rollers 112 to help direct the movement of the membrane material during operation of the robot 10. More specifically, the core 22 includes a first set of rollers 114a positioned proximate the first end 116 of the body 108 and a second set of rollers 114b positioned proximate the second end 120 of the body 108. Together, the two sets of rollers 114a, 114b serve to direct the membrane material into and through the central passage 124, with the second set of rollers 112b generally operating to help collect the membrane material as it inverts proximate the trailing end 30. Depending on the length of the core 22 relative to the membrane 14, the first set of rollers 114a may serve to direct and organize the membrane material as it everts at the leading end 26. As shown in FIG. 2C, the guide rollers 114a, 114b may also help support and position the core 22 upon the tail 74 so that the core 22 is spaced a distance from the outer wall portion 66 in all radial directions. Still further, the second set of rollers 112b may also be used for grounding the core 22 against the trailing wall portion 86 of the membrane 14 (e.g., grounding force F_{g}, see FIG. 4A).

Each guide roller 112 is a free-wheeling roller rotatably mounted to the body 108 of the core 22 for rotation about a corresponding axis of rotation. More specifically, each roller 112 is oriented radially relative to the core axis 104 with the corresponding axis of rotation being perpendicular thereto. In the illustrated embodiment, each set 114a, 114b includes three rollers 112 circumferentially spaced equally from each other and encompassing a corresponding end of the central passage 124. In other embodiments, more or few rollers 112 may be used in each set 114a, 114b. In still other embodiments, one or both sets or rollers 114a, 114b may be omitted from the core 22 as needed. In the illustrated embodiment, each roller 112 is fitted with two sets of ball bearings (see FIG. 2A) to minimize the potential for twisting during operation.

As shown in FIG. 2A, each set 114a, 114b of rollers 112 is mounted to the body 108 via a corresponding mount or endcap 128. Both endcaps 128a, 128b include an annular ring or base 132 that is sized and shaped to be mounted to a corresponding end 116, 120 of the body 108, and a plurality of pairs of standoffs or arms 136 extending from the base 132 to establish the actual mounting location and rotation axis of each roller 112. In the illustrated embodiment, each standoff 136 includes a pair of arms that extend axially away from the body 108 and radially inward toward the core axis 104. In other embodiments, the relative position and layout of the rollers 112 in each set 114a, 114b may be adjusted to better accommodate the simultaneously inverting and everting process of the membrane 14.

The core 22 also includes a drive mechanism 118 coupled to the body 108 and configured to engage the tail 74 of the membrane 14 to exert a force thereto. More specifically, the drive mechanism 118 is configured to convey the tail 74 in a single direction (e.g., toward the leading end 26) which causes the entire membrane 14 to circulate and the robot 10 to move. The drive mechanism 118 includes one or more motors 144, and one or more driven rollers 148 in operable communication with the motors 144 and configured to engage and exert a force against the membrane material.

In the illustrated embodiment, the drive mechanism 118 includes two DC electric motors 144 that are nested within a corresponding one of the driven rollers 148 to produce a motor/roller combination (see FIG. 2A). The resulting motor/roller combinations are then mounted transversely within the body 108 so that they intersect the central passage 124 perpendicular to the core axis 104. The motor/roller combinations are also positioned in close proximity to each other so that they produce a pinch-point therebetween sized to capture or otherwise engage the tail 74 when positioned therein.

During operation, a current or other electrical signals may be applied to the motors 144 causing the rollers 148 to counter-rotate relative to each other. When rotating, the rollers 148 then engage and pull the tail 74 of the membrane 14 toward the leading end 26. The user may vary the current or signals provided to the motors 144 to adjust the torque and speed at which the rollers 148 are driven and, consequently, the speed at which the robot 10 moves. Furthermore, the current or signals may be sent to reverse the direction of rotation of the motors 144 so that the rollers 148 pull the tail 74 toward the trailing edge 30, causing the robot to travel in a second direction 36 opposite the first direction 34.

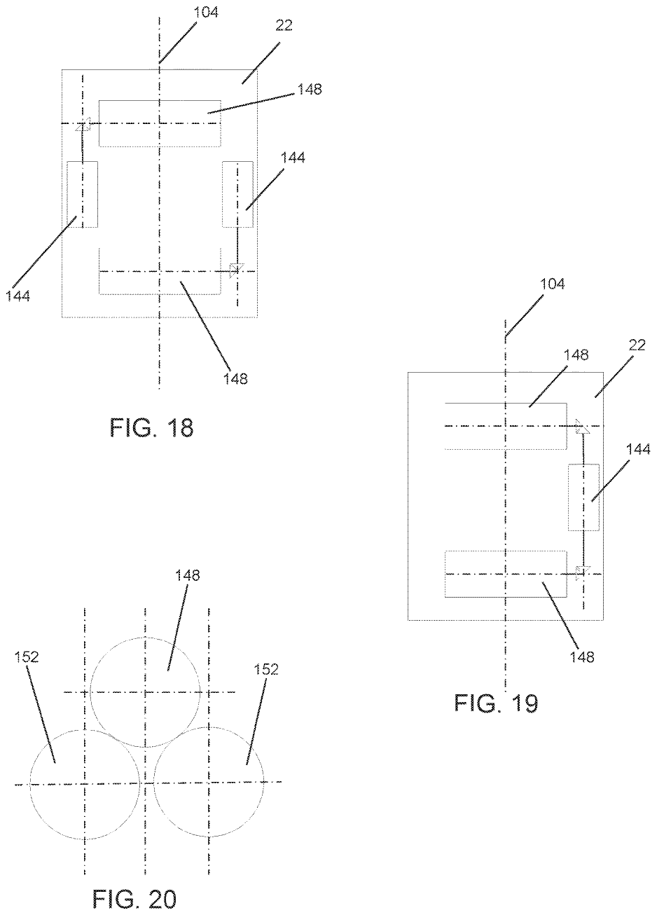

While the illustrated drive mechanism 118 is shown having two motor/roller combinations where both the motors 144 and rollers 148 are oriented perpendicular to the core axis 104, it is understood that in other embodiments different combinations and layouts of motors 144 and drive rollers 148 may be used. In some embodiments, the rollers 148 may remain perpendicular to the axis 104 but the motors 144 may be mounted remotely therefrom and oriented parallel to the axis 104 (see FIG. 18). In such embodiments, the motors 144 may drive the rollers 148 via a gear train (e.g., bevel gears, and a worm gear), belts, and the like.

Furthermore, while the illustrated embodiment has a dedicated motor 144 for each roller 148, it is understood that in other embodiments that a single motor 144 may be used to drive multiple drive rollers 148 (see FIG. 19). Still further, while the illustrated drive mechanism 118 only includes drive rollers 148, it is understood that in other embodiments free-wheeling tension rollers 152 may be incorporated into the drive mechanism (see FIG. 20). In such embodiments, one or more tension rollers 152 would be placed immediately adjacent a corresponding drive roller 148 to produce a corresponding pinch-point therebetween, with each pinch point providing a location where the rollers can apply force to the membrane 14 extending therethrough.

In some embodiments, each drive roller 148 may include a texture formed therein, a high-frictional coating applied thereto, a high-friction sleeve installed thereon, and the like to increase the level grip between the drive roller 148 and the tail 74 of the membrane 14.

In still other embodiments, the drive mechanism 118 includes a different form of propulsion either in combination with or in place of the drive rollers 148. Such systems may include, but are not limited to, a linear actuator, retraction device, ratcheting system, a pneumatically actuated clamping system, and the like.

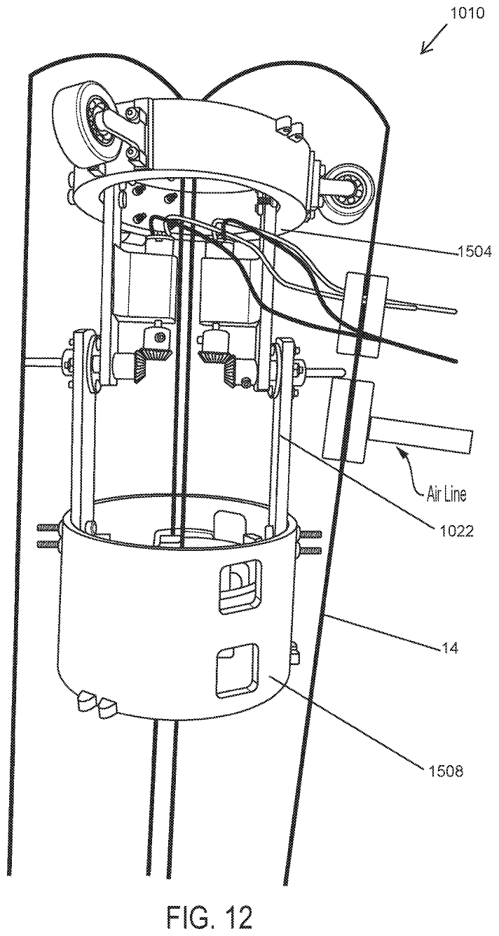

As shown in FIG. 2D, the core 22 may also include a power source 156 to provide electrical energy to any electrical components incorporated in or attached to the robot 10. In the illustrated embodiment, the power source 156 includes a battery pack that is attached to the body 108 and positioned within the volume 18 therewith. More specifically, a lithium polymer battery (RDQ5000-7.4-5, Race Day Quads, Orlando, FL) may power the device. In such embodiments, the battery may be removable from the volume 18 or rechargeable in situ. In other embodiments, the power source 156 may include a remote wired connection that passes through the membrane 14 (see FIG. 12).

In some embodiments, the core 22 may also include a fluid output device 160 to manage the volume/pressure of fluid within the volume 18. More specifically, the fluid output device 160 may include a reservoir of air or other fluids that can be released or otherwise pumped into the volume 18 to inflate or otherwise increase the volume or pressure of fluid within the volume 18. In still other embodiments, the fluid output device 160 may also include some sort of valve or fluid control device to allow fluid to be exhausted from the volume 18. Together, the device 160 allows the user to both increase (e.g., via the reservoir) or decrease (e.g., via the valve) the pressure within the volume 18 during operation of the robot 10. In other embodiments, a remote unit (not shown) may provide regulated air or fluid to the volume 18 via an external line extending through the membrane 14 (see FIG. 12).

The core 22 also includes a controller or microcontroller 164 incorporated therein. The controller 164, in turn, includes memory 180 for storing data and a processor 184 in operable communication with the memory 180. The processor 184, in turn, is configured to send and receive data from memory, execute programs, and send and receive data with other internal and external devices.

In the illustrated embodiment, the controller 164 is in operable communication with both motors 144 and the power source 156. More specifically, the controller 164 is configured to output signals to the motors 144 directing the speed and direction of rotation during use. In other embodiments, the controller 164 may also be in operable communication with any other sensors or electrical elements incorporated into the robot 10 (e.g., thermocouples, light sensors, lights, cameras, GPS units, proximity sensors, 3D localization sensors, the fluid output device 160, and the like). In the illustrated embodiment, the control system 164 also includes a wireless transmitter 170 in operable communication with the processor 184 to exchange wireless signals with one or more external devices such as a remote user interface 174.

The user interface 174 allows the user to send and receive instructions and data with the robot 10 regarding the current operating conditions. The user interface 174 may include various forms of screens, touch-screens, and/or buttons to allow such instructions to be conveyed. The user interface 174 may include, but is not limited to, a computer, a tablet, a cell phone, a dedicated control console, an integrated control panel, and the like. In the illustrated embodiment, the user interface 174 is a detached, independent unit that is configured to exchange data with the controller 164 via the wireless transmitter 170. However, in other embodiments the user interface 174 may include a wired connection in communication with all or a portion of the robot 10.

During operation, the user may send and receive instructions and data with the robot 10 wirelessly via the user interface 174. Upon receipt of the instructions, the processor 184 of the controller 164 is configured to enter any received information (e.g., from the user interface 174, sensors, and the like) into one or more control algorithms and then output any calculated instructions to the motors 144. Such instructions may include, but are not limited to, the desired direction of travel (e.g., in the first direction of travel 34, or in the second direction of travel 36), and the desired speed at which the robot 10 should move.

In some embodiments, the controller 164 may be simplified so that only a single control signal is needed to control the robot (e.g., stop or go). In such embodiments the direction of travel and speed may be pre-set ahead of time. Furthermore, the robot 10 is configured so that it would automatically travel along the three-dimensional passageway so no turning or navigating would be required. In other embodiments, more instructions may be sent to allow the user to more exactly control the motion of the robot 10 during use. For example, the user may instruct the robot to turn left or right (discussed below), input a pre-determined travel distance, set forth a route or set of GPS points for the robot 10 to follow, establish emergency stop parameters, and the like.

In still other embodiments, the robot 10 may have an autonomous drive mode whereby the controller 164 automatically selects the speed, direction, and distance traveled by the robot 10 based on control algorithms taking into account at least one of sensed 3D proximity data, pre-determined map data of the area to be traveled, GPS location data, manually entered user data, and the like.

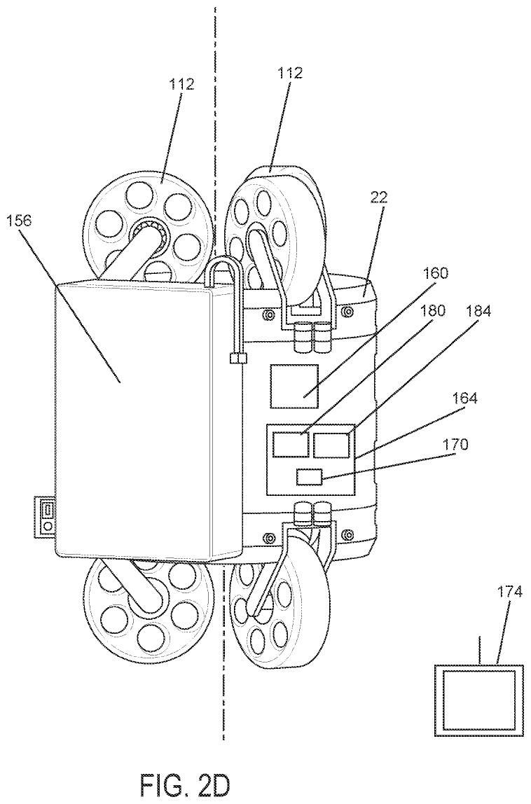

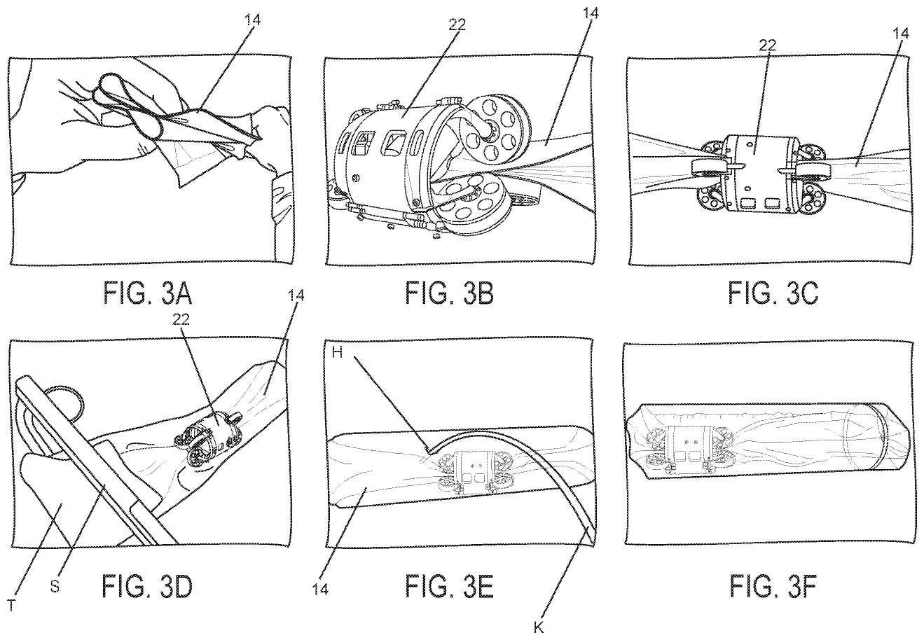

To assemble the robot 10, the user must pair the core 22 with the corresponding membrane 14. To do so, the user first selects the type and thickness of material (e.g., LDPE) to be used based on the nature of the environment the robot 10 is going to traverse. The user then procures a sheet of that material in the appropriate dimensions. As shown in FIG. 3A, the user then folds the sheet of membrane material into four layers. Once folded, the user may then insert the tip of the membrane material into the central passage 124 via the trailing end 120 until the material engages the pinch point between the two rollers 148 of the drive mechanism 118 (see FIG. 3B). After the membrane material is in position, the user may then activate the drive mechanism 118 (e.g., by inputting the appropriate instructions into the user interface 174) causing the rollers 148 to capture the membrane material and begin feeding it toward and out of the channel 124 via the leading end 116 (see FIG. 3C) until about two thirds of the overall length of the material has been pulled through.

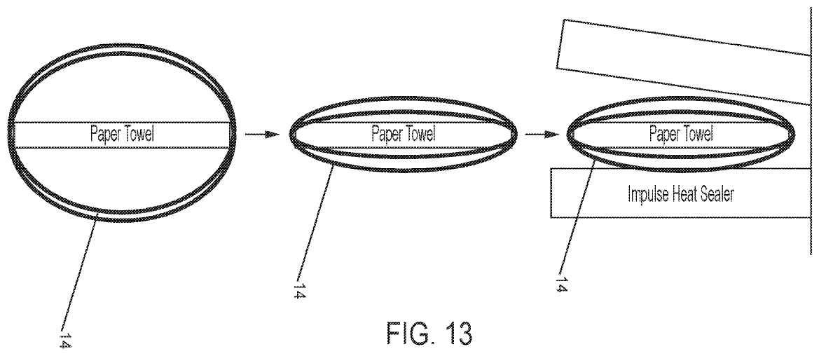

The user then folds the material back over the core 22 until both ends of the original length of material are brought together behind the trailing end 120 of the core 22d. A paper towel or other insulating element T is then placed between the innermost layers of the material (see FIG. 13) and an impulse heat sealer applied (S; see FIG. 3D). The sealing then fluidly seals the material creating a fluid-tight central volume 18 and the overall toroidal membrane 14 shape. The presence of the paper towel assures that the innermost layers do not fuse so that the central channel 62 is created.

With the membrane 14 formed the user may then inflate the central volume 18 with compressed air or other fluids as desired. To do so, the user may form a hole H in the wall 42 of the material and introduce a tube or other element K to pump air into the volume 18 (see FIG. 3E). Once the desired pressure or volume of fluid has been reached, the user can then remove the tube and patch the hole (see FIG. 3F). In embodiments where a fluid output device 160 is present, the output device 10 may fill the volume 18 without the need to puncture the membrane 14.

Once assembled, the robot 10 may then propel itself across a surface, such as across a substantially open, horizontal floor (see FIG. 1). More specifically, the user may input an instruction into the user interface (e.g., “go” or “proceed”) whereby the controller 164 will output the necessary signals to the motors 144 causing them to drive the pair of drive rollers 148 in a counter-rotating fashion (described above). The rollers 148 then engage the tail 74 of the membrane 14 and advance it toward the leading end 26 of the robot 10. The advancement of the tail 74, in turn, causes the membrane material to simultaneously evert (see element E of FIG. 1) from the central channel 62 proximate the leading end 26 and invert (see element I of FIG. 1) into the central channel 62 proximate the trailing end 30. Together, the combined inversion and eversion action causes the exterior wall portion 66 to advance generally axially toward the trailing end 30 of the robot 10 which conveys the robot 10 across the floor in a forward direction 34. As shown in FIG. 1, the frictional engagement between the exterior wall portion 66 then propels the robot 10 forward in the first direction 34.

As shown in FIG. 1, the circulating action produced by the membrane 14 in response to the forces applied by the rollers 148 results in the exterior surface 38 of the membrane 14 propelling the robot 10 in the first direction 34 while the outer surface 38 itself remains in stationary contact with the surrounding environment similar to a tank tread. This stationary contact helps minimize the amount of damage or wear that is exerted upon the membrane 14 during use and also allows for the membrane 14 to more easily address any obstructions or debris that may lay in the travel path.

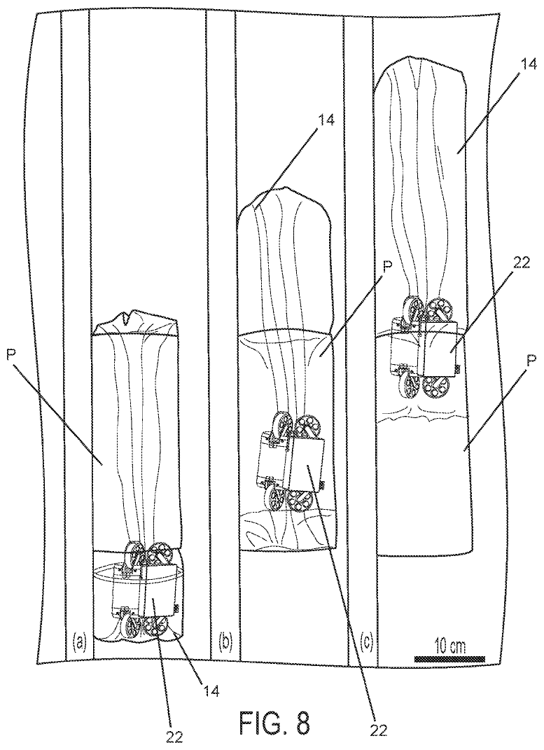

In addition to traversing flat, open ground as shown in FIG. 1, the robot 10 can also travel along inclined passages, including vertically in enclosed and semi-enclosed spaces. As shown in FIG. 8, the robot 10 is able to climb vertically through a pipe P by using the air pressure within the internal volume 18 to force the exterior surface 38 of the membrane 14 into engagement with the pipe P itself. The engagement, in turn, generates sufficient holding or slipping force (Fₚ; see FIG. 4A) to overcome the force of gravity and maintain the robot 10 in place. As is shown in panel (a) of FIG. 8, the air pressure within the central volume 18 and the shape and construction of the membrane 14 is such that the air pressure within the membrane 18 can generate sufficient holding force against the pipe even when the core 22 itself has not yet entered the pipe P. Stated differently, the holding force generated by the membrane 14 via the air pressure inside the volume 18 is completely independent from the operation and structure of the core 22.

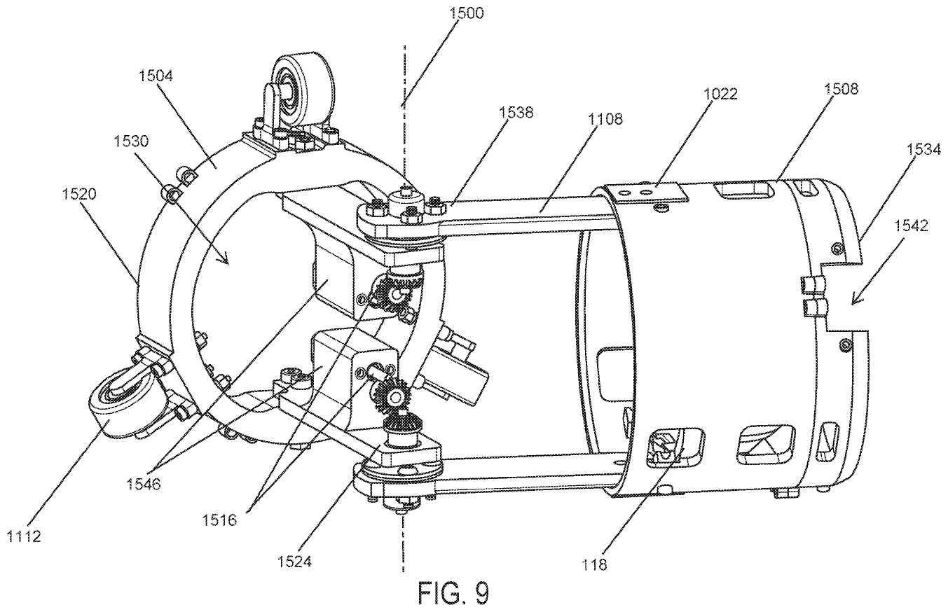

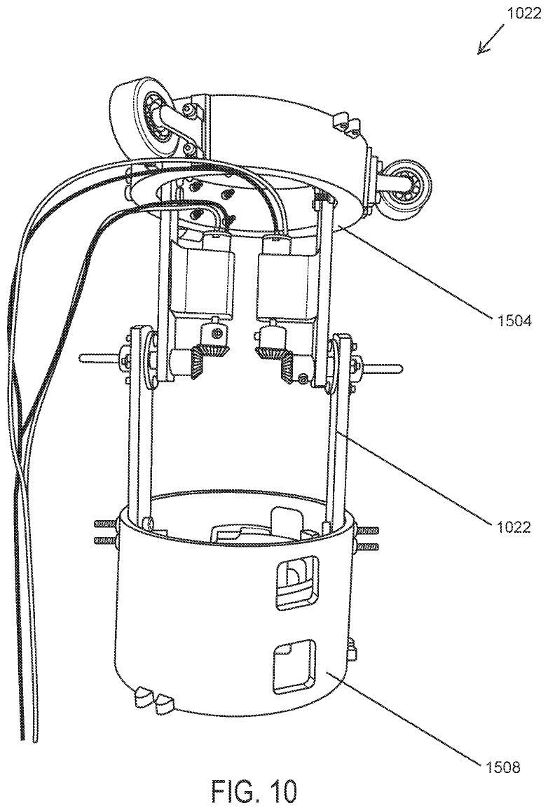

FIGS. 9-16 illustrate another embodiment of the robot 1010. The robot 1010 is substantially similar to the robot 10 described above so only the differences will be described in detail herein. As shown in FIG. 9, the core 1022 of the robot 1010 includes an articulated body 1108 such that the robot has two degrees of freedom when traveling. The first degree of freedom being the ability to circulate the membrane 14 forward and backwards, and the second degree of freedom to turn side-to-side about the axis of articulation 1500.

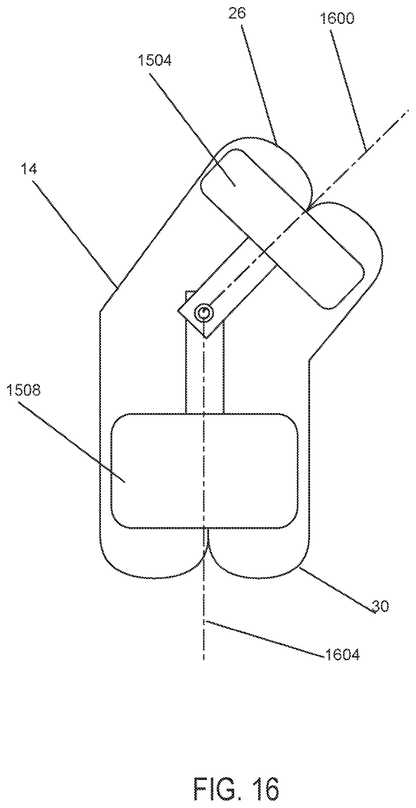

As shown in FIG. 9, the body 1108 has a first or forward portion 1504 and a second or trailing portion 1508 pivotably coupled to the first portion 1504 for rotation about the axis of articulation 1500. During use, the user may input one or more signals into the user interface 174 whereby the controller 164 instructs one or more actuators 1516 to rotate the first portion 1504 relative to the second portion 1508 about the axis of articulation 1500 (e.g., to rotate the central axis 1600 of the first portion 1504 to a given angle relative to the central axis 1604 of the second portion 1508, compare FIG. 15 to FIG. 16).

As shown in FIG. 9, the first portion 1504 of the body 1108 includes a leading end 1520 and a first pivot end 1524 opposite the leading end 1520. The leading end 1520, in turn, is substantially circular in shape defining an outlet or opening 1530 therein. The leading end 1520 also includes a plurality of rollers 1112 rotatably coupled thereto. In the illustrated embodiment, the first portion 1504 includes three rollers 1112 attached to the radial exterior of the first portion 1504 proximate the leading end 1520 to help aid the eversion of the membrane material as it extends out of the opening 1530.

The first portion 1504 also includes a pair of mounting bosses 1546, each configured to support a corresponding one of the two actuators 1516 therein. More specifically, the illustrated bosses 1546 maintain the actuators 1516 such that they are generally parallel with the first portion core axis 1600 (see FIG. 16). However, in other embodiments different mounting solutions for the actuators 1516 may be used.

The second portion 1508 of the body 1108 includes a trailing end 1534 and a second pivot end 1538. The trailing end 1534, in turn, is substantially circular in shape defining an inlet or opening 1542 therein. The second portion 1508 also includes a mounting location for the drive mechanism 118 (discussed above).

When assembled, the first pivot end 1524 and the second pivot end 1538 are pivotably coupled together to form the combined body 1108 and define the axis of articulation 1500. In the illustrated embodiment, a pair of bevel gears are incorporated into the resulting joints to allow the actuators 1516 to establish the desired articulation angle between the first portion 1504 and the second portion 1508 by apply torque thereto. However, in other embodiments different forms of articulation control may be incorporated into the device such as, but not limited to, belts, linear actuators, and the like.

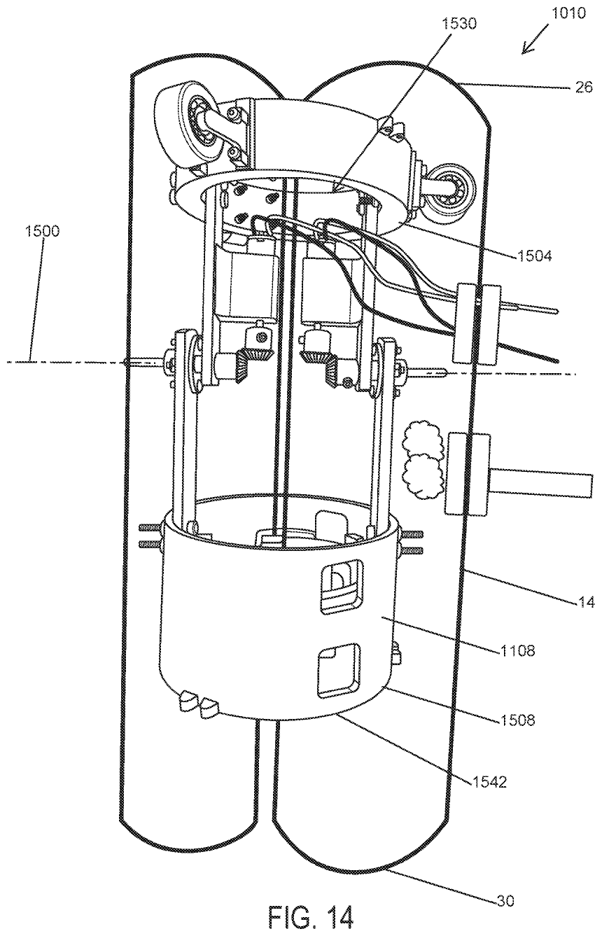

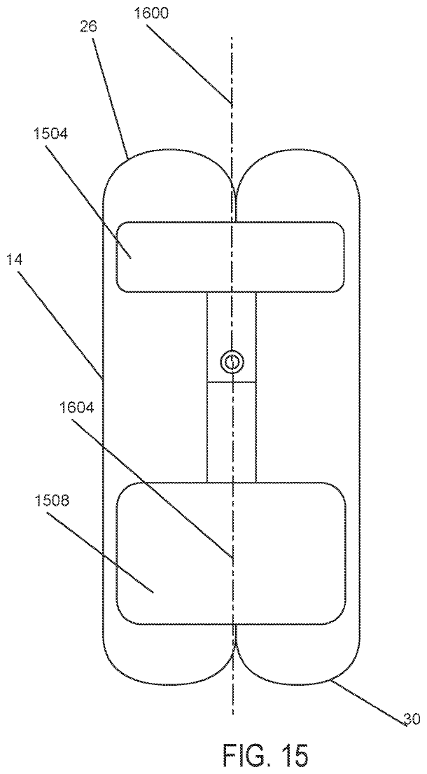

When the membrane 14 is installed on the core 1022, the tail 74 of the membrane 14 is configured to extend through the body 1108 of the core 1022 passing through both the inlet 1542 and the outlet 1530 (see FIG. 14). By passing through both apertures 1542, 1530, the articulation of the first portion 1504 relative to the second portion 1508 also causes the leading end 26 of the membrane 14 to articulate relative to the trailing end 30 of the membrane (compare FIGS. 15 and 16). As such, the user can manipulate the articulation angle between the first portion 1504 and the second portion 1508 to steer or otherwise control the direction of travel along an arc that is oriented perpendicular to the articulation axis 1500. In other embodiments, a pair of compound joints may be present to allow an additional degree of freedom (e.g., both horizontal and vertical adjustment).

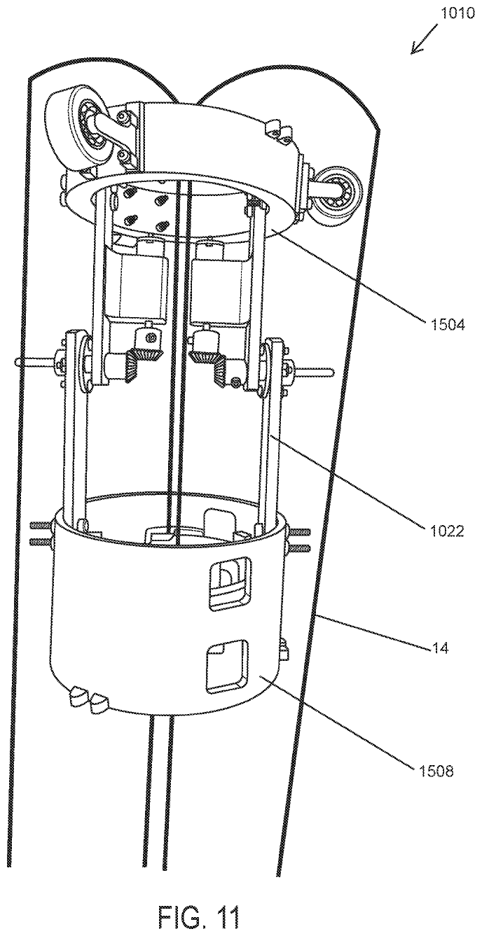

As shown in FIGS. 11-14, the membrane 14 may be installed onto the core 1022 in substantially the same manner it is installed on the core 22. More specifically, a length of membrane material is inserted into the inlet 1542 and the drive mechanism 118 run until approximately ⅔^{rd} of the overall length of the membrane material extends out from the outlet 1530. Once that is complete, the user can then fold the membrane material back onto the core 1022 until both loose ends of the material generally line up (see FIG. 11). With that step complete, a paper towel or other insulating piece of material may be positioned between the innermost layers of material and a seal is made via an impulse heat sealer (see FIG. 13). The interior volume 18 is then air-tight.

With the seal made, any necessary electrical, fluid, or other connections may be made by passing the necessary items through holes in the membrane 14 itself. More specifically, hard wire and/or fluid management connections may be established and the volume 18 filled to the desired pressure or volume (see FIG. 14). Depending on the final operating conditions, the hard wire and/or fluid management connections may be removed and re-sealed after initial preparations are complete.

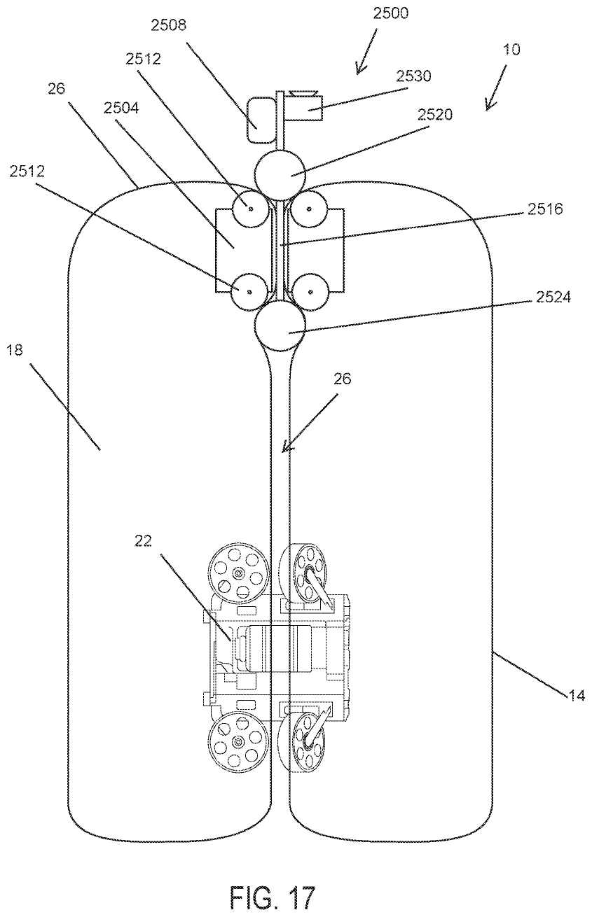

FIG. 17 illustrates the robot 10 with an external camera assembly 2500 removably attached thereto. More specifically, the external camera assembly 2500 includes an internal mount portion 1504 and an external mount portion 2508. The internal mount portion 2504 is substantially annular in shape being sized and shaped to be placed in the central volume 18 of the membrane 14 between the core 22 and the leading end 26. The internal mount portion 2504 also includes two sets of wheels or rollers 2512 spaced a pre-determined axial distance from one another at a radial distance from the axis 104 that generally corresponds to the size of the central channel 62. While the illustrated internal mount portion 1504 is shown freely positioned within the volume 18, it is understood that in other embodiments the mount 1504 may be fixed attached to the core 22 to establish a fixed distance therebetween.

The exterior mount portion 2508 includes a rod 2516, a first locking ball 2520 fixedly mounted to the rod 2516, a second locking ball 2524 spaced a predetermined distance from the first locking ball 2520 and also fixedly mounted to the rod 2516, and a camera assembly 2530 mounted to the distal end of the rod 2516 opposite the second locking ball 2524.

During use, the locking balls 2520, 2524 are sized and spaced from one another to substantially correspond with the relative location of the rollers 2512 of the internal mount portion 1504. The resulting interaction allows the membrane 14 to travel between the internal and external mounting elements 2504, 2508 during locomotion, but restricts the relative motion between the two items to maintain the exterior mount portion 2058 in a generally co-axial alignment with the axis 2104.

More specifically, the balls 2520, 2524 are size and spaced so that they partially encompass the rollers 2512 therebetween such that the rollers 2512 are “nested” therein. By doing so, despite not having any direct contact, the internal mount portion 1504 is able to maintain the position of the external mount portion 1508 relative to the core 22 and membrane 14.

In the illustrated embodiment, the camera assembly 2530 of the external camera assembly 2500 is generally pointed in a “forward” direction parallel to the direction of travel 34. However, in other embodiments, the camera may be re-directable to point the field of view in different directions relative to the robot 10. Furthermore, the camera itself may be hard-wired back to a home unit (e.g., via the channel 26), communicate wirelessly with the robot 10 via the wireless transmitter, and/or communicate wirelessly with a remote control or user interface.

While the illustrated assembly 2500 is shown extending from the leading end 26, it is understood that in other embodiments the same or another assembly 2500 may be installed so that it extends from the trailing end 30 as well.

### Slipping Force Experiment

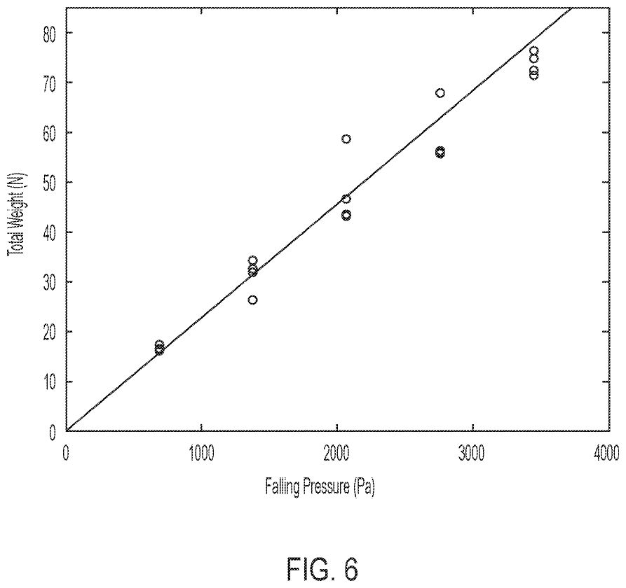

To experimentally validate the relationship between slipping force, air pressure, and pipe geometry, we conducted a set of experiments where the robot 10 was suspended inside a vertical pipe, and we measured the minimum applied force required to cause it to begin slipping at various pressures. The results of this experiment are shown in FIG. 6 with the circles representing measured data points and the solid line is the model from the below-described equation.

An equation generally modeling the situation is shown below with Wₘ representing the weight of the membrane 14, W_{d} representing the weight of the core 22, μₛ representing the statis coefficient of friction between the membrane 14 and the pipe, P representing the internal pressure within the central volume 18, R representing the inner radius of the pipe, and L representing the axial length of the robot 10 in contact with the pipe (see FIGS. 4A-4C).

$${W}_{m} + {W}_{d} = {μ}_{s} [ P ( 2 π RL ) ] .$$

The static coefficient of friction μₛ was determined by placing an LDPE membrane on top of an acrylic panel with a weight on top. We measured the force needed to begin moving the membrane with a digital scale (ES-PS01, Dr. Meter). Five values were collected and averaged to find that μₛ is approximately 0.192.

For validating the model, we used a 19.4 cm inflated diameter LDPE membrane sealed through its entire cross section to form a tube. We placed the membrane inside of a vertical acrylic pipe of 12.4 cm in diameter and 30.5 cm in length and wrapped a high strength fishing string around the membrane vertically. The membrane was longer than the pipe, so we used the pipe length as the length of contact. We then filled the membrane using a pressure regulator (QB3, Proportion-Air, McCordsville, IN) at five values ranging from 0.70 kPa to 3.45 kPa. We attached the digital scale to the bottom of the string and measured the force it would take for the membrane to fall at each pressure value. Four trials were completed for each pressure value. The results were plotted and compared to our model (FIG. 6), which showed good agreement.

### Locomotion Demonstration

We conducted a set of demonstrations to showcase the locomotive and compliant functionality of the everting toroidal robot. These demonstrations could be considered as mock scenarios similar to what might be seen in a search and rescue mission, such as navigating through collapsed structures horizontally and vertically. In these demonstrations, the robot successfully traverses a zigzagging maze with a small aperture, and it climbs up a pipe.

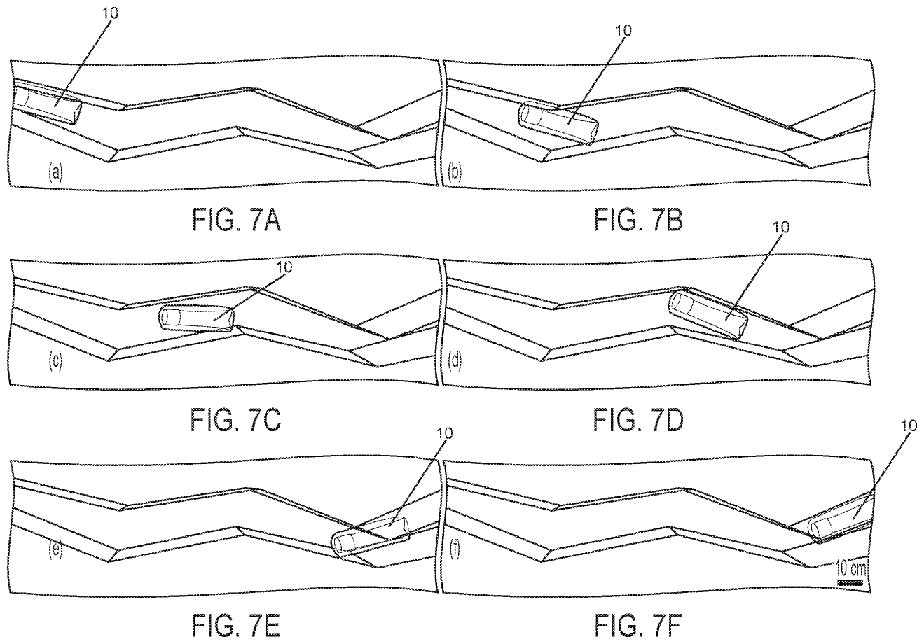

For the maze demonstration, we constructed a maze by fixing acrylic panels to a cardboard base. The panels form a zigzagging path with variable spacing between them. As shown in FIG. 7, the robot 10 successfully traversed the maze. As the robot 10 passes through the maze, it is forced to change direction multiple times as it comes into contact with a wall. Due to the robot's natural compliance and its eversion mechanism, the robot 10 is able to turn to move along the wall, without any active steering (FIGS. 7A-7D)). At the end of the maze (FIGS. 7E-7f)), the robot 10 encounters an aperture of width 11 cm, which is smaller than the diameter of the membrane (13.7 cm) but larger than the diameter of the propulsion device with the battery (10.4 cm). To navigate the aperture, the membrane squeezes laterally and elongates vertically.

### Propulsion Force Experiment

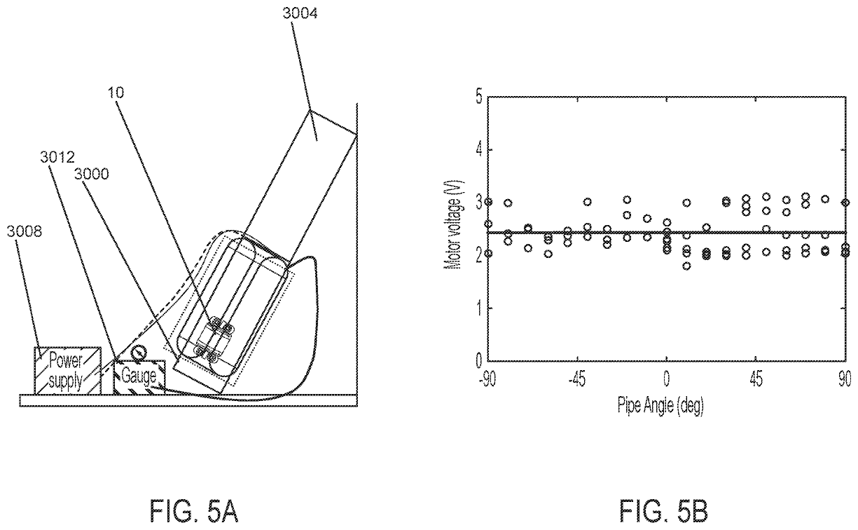

FIGS. 5A and 5B illustrate a propulsion force validation experiment where we tested the minimum propulsion device motor voltage required to make the robot 10 begin climbing a pipe at different angles relative to horizontal. The setup includes a wood plank 3000, acrylic pipe 3004, power supply 3008, pressure gauge 3012, and the robot 10 (see FIG. 5A). We then experimentally determined values of the minimum motor voltage required to climb up or down the pipe. Positive pipe angles denote that the robot is climbing upwards, and negative pipe angles denote that the robot is climbing downwards. The circles are measured data points, and the solid line is the average voltage required for all of the trials (2.43 V).

FIG. 5B shows the results. The trials where the robot is climbing up are plotted as 0° to 90° and climbing down from 0° to −90°. The results show that, while the motor voltage varied between trials by approximately 1 V, there is very little dependence of the motor voltage on the pipe angle. The average voltage across all trials, plotted in the solid line, was 2.43 V. We also repeated these experiments at a range of pressures and did not see a change in the results.

These results are interesting, as they indicate that force losses between the motor output shaft and the membrane make up a significant portion of the voltage required by the device motors, which means that the dependence of the operating voltage on the robot weight and thus the angle of propulsion is very small. If the robot weight increases significantly (e.g., to 10x or 100x the current weight), the dependent of the device propulsion force on the pipe angle will become significant, but for our current robot designs, the robot can easily propel itself at any angle without an appreciable change in operating voltage.

1) A self-propelled robot comprising:
a membrane defining a membrane axis therethrough, wherein the membrane includes a first end and a second end opposite the first end, wherein the membrane defines a central volume therein, and wherein the membrane includes a central channel extending axially therethrough that is open to both the first end and the second end; and
a core positioned within the central volume, wherein the core includes a drive mechanism configured to engage and circulate the membrane about an infinite loop.

2) The self-propelled robot of claim 1, wherein the membrane is toroidal in shape.

3) The self-propelled robot of claim 1, wherein the membrane includes a single continuous outer surface and a single continuous inner surface.

4) The self-propelled robot of claim 1, wherein the central volume is fluid-tight.

5) The self-propelled robot of claim 1, wherein the membrane is formed from material that is between 0.1 mm and 0.5 mm thick.

6) The self-propelled robot of claim 1, wherein the three-dimensional shape of the membrane is defined by a wall profile rotated 360 degrees about the membrane axes, and wherein the wall profile includes a wall forming a closed shape.

7) The self-propelled robot of claim 1, wherein the toroidal membrane includes a tail including the portion of the membrane forming the central volume, and wherein the drive mechanism engages and biases the tail axially toward the first end.

8) The self-propelled robot of claim 1, wherein the drive mechanism includes a pair of rollers each rotatable about a corresponding roller axes, and wherein the rollers are positioned such that both roller axes are oriented perpendicular to the membrane axes.

9) The self-propelled robot of claim 7, wherein the rollers are positioned adjacent one another to form a pinch-point therebetween, and wherein at least a portion of the toroidal membrane passes through the pinch-point.

10) The self-propelled robot of claim 1, wherein circulating the membrane about an infinite loop includes everting the membrane as it extends from the central channel proximate the first end, and inverting the membrane as it retracts into the central channel proximate the second end.

11) The self-propelled robot of claim 1, wherein the central volume remains substantially constant as the membrane circulates about the infinite loop.

12) A self-propelled robot comprising:
a membrane defining a membrane axis therethrough, where the membrane includes a first end and a second end opposite the first end, where the membrane defines a fluid-tight central volume therein, and wherein the membrane includes a central channel extending co-axially with the membrane axis therethrough that is open to both the first end and the second end; and
a core positioned within the central volume, wherein the core includes a drive mechanism configured to engage and apply a force to the membrane during use.

13) The self-propelled robot of claim 12, wherein applying a force to the membrane causes the self-propelled robot to travel in a first direction parallel to the membrane axis.

14) The self-propelled robot of claim 12, wherein the membrane is toroidal in shape.

15) The self-propelled robot of claim 12, further comprising a controller positioned in the central channel and in operable communication with the drive mechanism, wherein the controller receives signals wirelessly via a wireless receiver.

16) The self-propelled robot of claim 15, wherein the controller receives signals wirelessly from a remote user interface.

17) The self-propelled robot of claim 12, wherein the core includes a first portion and a second portion pivotable relative to the first portion about an axis that is oriented perpendicular to the membrane axis.

18) The self-propelled robot of claim 17, wherein the central channel passes through both the first portion and the second portion of the core.

19) The self-propelled robot of claim 17, wherein the dive mechanism is attached to the second portion of the core.
